(19) United States
(12) Patent Application Publication
(10) Pub. No.: US 2002/0154831 A1
(43) Pub. Date: Oct. 24, 2002

(54) Method for retouching screened binary image data redigitized in pixels

(76) Inventors: Michael Hansen, Kiel (DE); Erich Selder, Frankfurt Am Main (DE); Jorg Olaf Von Wechgeln, Wattenbek (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/103,354

(22) Filed: Mar. 21, 2002

(30) Foreign Application Priority Data
Mar. 21, 2001 (DE) 101 13 872.5
Jan. 31, 2002 (DE) 102 03 905.4

(51) Int. Cl. G06K 9/40; G06T 5/00; G06T 5/30; H04N 1/409; G06K 9/44

(52) U.S. Cl. 382/257; 382/275

(57) ABSTRACT

Binary screen image data redigitized in pixels are retouched, specifically to eliminate local screen defects such as dust artifacts and scratch artifacts. Defective screen dots are selected and recorded for the purpose of detecting screen defects. Then, dust artifacts and scratch artifacts or the like are removed from contaminated image data. Furthermore, missing points in the screen are also filled up, and inhomogeneous image regions are corrected in part. The production of visible moire effects in the retouched image data is avoided by the replacement of only small areas.

### BACKGROUND OF THE INVENTION

### FIELD OF THE INVENTION

The invention relates to a method for retouching screened binary image data redigitized in pixels, preferably comprising the elimination of local screen defects, in particular of dust artifacts and scratch artifacts.

When screened originals are being redigitized by means of scanners, a wide variety of contaminants (dust, scratches, . . . ) may degrade the output quality of the binary image data. These faults may have arisen through wear, unsuitable storage, or inexpert handling. Again, defects in the scanner, for example a scratch in the glass or dust in the optical system, lead to an undesired deterioration in the output quality.

Various methods such as, for example, what is known as pixel cloning, or other types of retouching are exceptionally complicated and time consuming to operate on the binary image data when they are not congruent with the screen of the original. In the case of other methods, the screen dots are replaced over a larger area in the selected section, but this can then lead to moire effects and thereby degrade the output quality.

### SUMMARY OF THE INVENTION

It is accordingly an object of the invention to provide a method of retouching screened binary image data redigitized in pixels, which overcomes the above-mentioned disadvantages of the heretofore-known devices and methods of this general type and which improves retouching of the type mentioned above.

With the foregoing and other objects in view there is provided, in accordance with the invention, a method of retouching screened binary image data redigitized in pixels, in particular for eliminating local screen defects, such as dust artifacts and scratch artifacts. The method comprises selecting defective screen dots in the image and recording the defective screen dots for detecting screen defects.

In accordance with an added feature of the invention, all the possible screen dots are determined for the purpose of selecting defective screen dots in a selected screen region (image region), and the existing screen structure is analyzed.

In accordance with an additional feature of the invention, addressed (“blackened”) pixels arranged immediately adjacent to one another are regarded as forming a screen dot.

In accordance with another feature of the invention, in order to avoid screen dot contacts between mutually adjacent screen dots, a uniform magnitude with a sufficiently small degree of area fill for a screen cell is achieved for the screen dots by means of a morphological erosion.

In accordance with a further feature of the invention, missing screen dots are selected and recorded as defective screen dots by comparing the determined screen dots and the possible screen dots.

In accordance with again an added feature of the invention, screen dots that are developed too much (dark) or too little (bright), i.e., screen dots outside an acceptable coverage range, by comparison with the average of a number of screen dots are selected and recorded as defective screen dots.

The method according to the invention may be dissected into two, preferably sequential, process sequences, namely:

A) the detection of contaminated and/or defective image regions in the screen surface according to one or more of the foregoing paragraphs; and

B) the replacement of the defective regions with suitable screen image data according to one or more of the following paragraphs.

That is, in accordance with yet a further feature of the invention, there is provided a method for retouching redigitized, screened originals, which comprises first performing a method as outlined in the foregoing paragraphs, and then correcting defective screen dots screen dot by screen dot.

In accordance with yet an additional feature of the invention, the correction of a defective screen dot is performed by interpolating adjacent, correct screen dots.

In accordance with yet another feature of the invention, the correction of a region with a plurality of defective screen dots is undertaken progressively (iteratively) in each case at the screen dot that has the most correct or already corrected screen dots for an interpolation in its neighborhood.

In accordance with a concomitant feature of the invention, interpolation of subpixel accuracy is performed on the basis of a displacement of the centers of the screen dots by means of suitable scale filters onto integral pixel coordinates and a subsequent simple averaging over the set pixels of a screen dot.

The present method eliminates, in particular, dust artifacts and scratch artifacts from contaminated image data. Furthermore, missing points are also filled up in the screen and inhomogeneous image regions are corrected in part. The production of visible moire effects in the retouched image data is avoided in this case with particular advantage by replacement of only small areas.

The first and second process sequences may be explained as follows:

### Part A: Detection of Defective Image Regions

A screen surface consists of elliptical or circular screen dots that are arranged generally in a rectangular screen. The screen is uniquely described by an origin (o,o) and a screen vector (u,v). The radius of a screen dot is a function of the associated area fill (0-100%) of the screen surface. By definition, a screen dot consists of black (set or addressed) pixels of the binary original. A defective image region is to be understood as a number of screen dots that, for example owing to contaminants, have an area fill deviating from their neighborhood, or which lie at an irregular screen position.

The detection of such a defective region is performed in the following three steps:

a) Finding all possible screen dots in the selected image region.

b) Local analysis of the screen structure.

c) Selection and recording of defective screen dots in a list.

a) The possible screen dots are found by a coherence analysis. The latter assigns adjacent black pixels to a screen dot. Since the given image or partial image can have different area fills, and the screen dots are coherent in part starting from what is termed the point closure region (approx. 50%), the given image must be suitably preprocessed. A uniform area fill of approx. 35%, which is required for the coherence analysis, is achieved by a morphological erosion. The result of the coherence analysis is a list of screen dots from which excessively large or excessively small points are expunged. These are not used for the subsequent screen reconstruction (see FIG. 1).

b) For the purpose of local reconstruction of the existing screen structure, each possible screen dot on the list is assigned a pixel coordinate (x,y) that describes its center.

In a rectangular screen, each regular position can be described by:

(x,y)=(o,o)+i(u,v)+j(−v,u)

where (i,j) are to be understood as what is termed the screen position of the screen dots. Simple optimization methods can be used to determine the previously unknown screen parameters (o,o) and (u,v) from a minimum number of 4 screen dots. These screen parameters are used in the following step to select the defective points from the multiplicity of possible screen dots.

c) The object of the invention is, in particular, the elimination of dust artifacts and scratch artifacts from screened originals. The corrected image is to have a complete screen dot structure that corresponds to the original and wherein each screen dot is described by its screen position. The list of screen dots found (in a) is transferred into the screen dot structure. Free screen positions, that is to say image regions wherein no screen dots were found, are entered as defects in the list.

In a further step, all the screen dots in occupied screen positions are entered as defective if their area fill deviates more strongly than a selected percentage value from the average area fill of the overall image or its local neighborhood. Screen dots that are globally or locally too bright or too dark are thereby rejected.

Together with the associated image pixels, the screen positions (i,j) entered in the list represent the totality of the defective image regions. Each screen position (i,j) thus represents a screen dot (see FIG. 2).

### Part B: Replacement of the Defective Image Regions

The replacement of the defective image regions is preferably performed by a local interpolation of subpixel accuracy, of the defective screen dots by means of suitable adjacent points. If, for example, only one defective screen dot is present, it is calculated from the screen dots adjacent in the screen structure when a minimum number of them is not defective. If too many defective screen dots are adjacent, the replacement is carried out iteratively, that is to say the points that have an adequate number of nondefective neighbors are the first to be replaced. They are then marked in the subsequent iteration as nondefective and used for further replacement of the screen dots that are still defective. Only once all the defective points have been replaced does the method end.

The interpolation, of subpixel accuracy, is based on a displacement of the centers of the screen dots by means of suitable scale filters onto integral pixel coordinates (x,y), and subsequent simple averaging over the set pixels of a screen dot.

Other features which are considered as characteristic for the invention are set forth in the appended claims.

Although the invention is illustrated and described herein as embodied in a method for retouching screened binary image data redigitized in pixels, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flowchart for the sequence of the method according to the invention for selecting defective screen dots; and

FIG. 2 is a flowchart for the sequence of the method according to the invention for replacing the defective regions.

### DESCRIPTION OF THE PREFERRED EMBODIMENTS

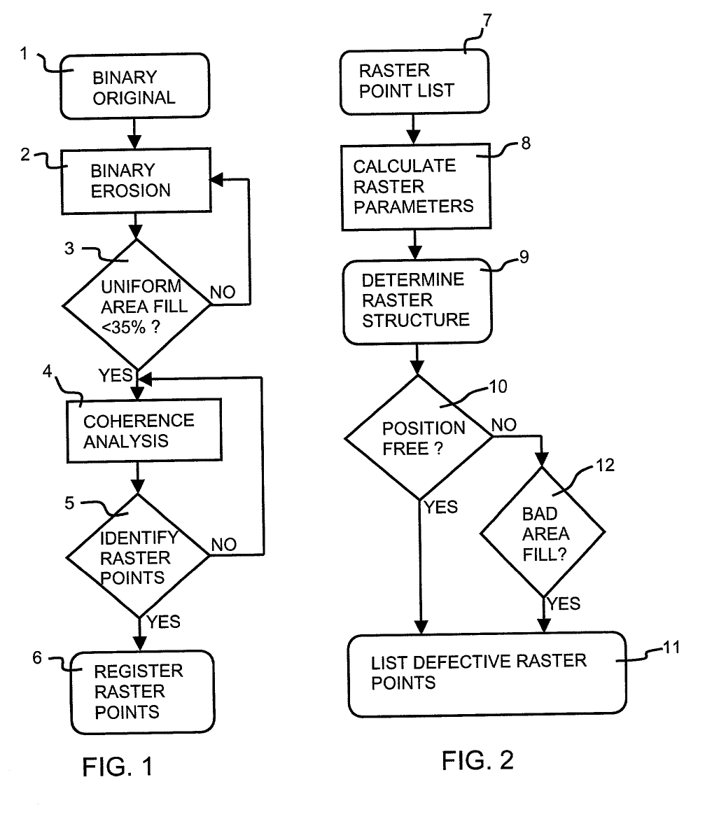

Referring now to the figures of the drawing in detail and first, particularly, to FIG. 1 thereof, the flowchart outlines the sequence of the method according to the invention for selecting defective screen dots up to their recording in a list in accordance with the above-described section A) of the method.

A binary original 1 to be corrected is taken at the start of the method, and this is followed by a binary erosion of the screen dots determined at 2. Reference is had to the above description concerning the determination and the carrying out of the erosion. This erosion is carried out via a loop with the aid of a yes/no interrogation 3 until the screen dots have a uniform area fill of their screen cells of<35%.

After the erosion, a coherence analysis is used at 4 to determine coherent pixels which are respectively assigned to a screen dot, as a result of which the screen dots are identified via the yes/no interrogation 5.

The identified screen dots are entered in a list 6 and recorded in this way.

With reference to FIG. 2, there is shown a flowchart for the sequence of the method according to the invention for replacing the defective regions in accordance with section B) of the method described above.

The list of the determined screen dots that is obtained at 6 in FIG. 1 is taken firstly at 7, and the screen parameters are calculated from it at 8. The screen structure is determined therefrom at 9, and thus the possible screen dots, as well.

A yes/no interrogation is used at 10 to find out whether the position of a possible screen dot is free or not. Thus, the list recorded at 6, and used at 7, of the screen dots thus determined is compared by individual screen dot with the list, which can be obtained, as it were, from 9, of the possible screen dots. Free screen positions determined therefrom are entered directly at 11 into a list of defective screen dots, while screen dots determined as existing are entered in the list of defective screen dots at 11 only when the result of a further interrogation at 12 is that the area fill is not correct in the case of the respectively determined screen dot, that is to say the screen dot is not correctly developed.

It should be stressed once again at this juncture, that the method according to the invention is provided, in particular, for the purpose of eliminating local screen defects such that larger areas, possibly intentionally unprinted regions of the original, need not be taken into consideration.

I claim:

1. A method of retouching screened binary image data redigitized in pixels, which comprises selecting defective screen dots in the image and recording the defective screen dots for detecting screen defects.

2. The method according to claim 1, which further comprises eliminating local screen defects determined in the detecting step.

3. The method according to claim 2, wherein the local screen defects are of a type selected from the group of dust artifacts and scratch artifacts.

4. The method according to claim 1, which comprises determining all possible screen dots for selecting defective screen dots in a selected screen region, and analyzing an existing screen structure.

5. The method according to claim 4, which comprises regarding addressed pixels arranged immediately adjacent to one another as forming a screen dot.

6. The method according to claim 5, which comprises, in order to avoid screen dot contacts between mutually adjacent screen dots, morphologically eroding given screen dots to obtain a uniform magnitude with a sufficiently small degree of area coverage for a screen cell.

7. The method according to claim 4, which comprises selecting and recording missing screen dots as being defective screen dots by comparing the determined screen dots and the possible screen dots.

8. The method according to claim 1, which comprises finding screen dots outside an acceptable coverage range by comparison with an average of a number of screen dots, and recording the screen dots outside the acceptable coverage range as defective screen dots.

9. A method of retouching redigitized, screened originals, which comprises selecting defective screen dots in the original by performing the method according to claim 1, and correcting the defective screen dots screen dot by screen dot.

10. The method according to claim 9, wherein the correcting step comprises interpolating adjacent, correct screen dots and using the interpolation to correct the defective screen dot.

11. The method according to claim 10, which comprises correcting a region with a plurality of defective screen dots progressively in each case at a screen dot that has the most correct or already corrected screen dots for an interpolation in its neighborhood.

12. The method according to claim 10, which comprises interpolating with subpixel accuracy based on a displacement of the centers of the screen dots by suitable scale filters onto integral pixel coordinates, and subsequently averaging over the set pixels of a screen dot.
